(19) United States
(12) Patent Application Publication
(10) Pub. No.: US 2022/0080903 A1
(43) Pub. Date: Mar. 17, 2022

(54) Vehicular Storage Apparatus

(71) Applicant: Harold Wright Ano, Ewa Beach, HI (US)

(72) Inventor: Harold Wright Ano, Ewa Beach, HI (US)

(21) Appl. No.: 17/476,405

(22) Filed: Sep. 15, 2021

Related U.S. Application Data
(60) Provisional application No. 63/079,614, filed on Sep. 17, 2020.

(51) Int. Cl. B60R 11/06; B60R 9/06

(52) U.S. Cl. CPC B60R 11/06; B60R 9/065

(57) ABSTRACT

A vehicular storage apparatus includes a main body, a first storage container, a second storage container, and a power source. The main body comprises a top wall, a first sidewall, a second sidewall, and a bottom wall each extending from a first end to a second end to form an interior space. A first partition is vertically positioned in the interior space to divide the interior space into a first compartment and a second compartment. The first storage container comprises a first storage compartment. The first storage container is positioned on top of the main body. The second storage container comprises a second storage compartment. The second storage container is positioned on top of the first storage container. Each of the first storage compartment and the second storage compartment extends longitudinally between the first end and the second end.

### FIELD OF THE INVENTION

The present invention relates generally to vehicular storage apparatuses. More specifically, the present invention is a vehicular storage apparatus that can be mounted within the rear of a vehicle. The present invention is specifically designed for pickup trucks. However, the present invention is not limited to this option, and it may further be adapted for different purposes.

### BACKGROUND OF THE INVENTION

A pickup truck (or pick-up truck or simply pickup) is a light motor vehicle with an open-top rear cargo area (bed) which is often separated from the cab to allow for chassis flex when carrying or pulling heavy loads on the heavier vehicles, as opposed to the lighter car-derived models. Apparatuses have been developed to organize the cargo area and to minimize the motion of transported articles located therein during periods of transit. For example, during certain types of transport, it is desirable to include a storage container in the rear of a pickup truck. The storage compartment serves to retain tools, and other items, so as to allow the user of the pickup truck to have access to such tools at the desired destination.

However, several drawbacks are associated with existing storage apparatuses. For instance, the existing storage apparatuses usually include only storage compartments for tools and thus lack versatility. Moreover, conventional storage apparatuses are often positioned in an extremely poor location, making it difficult for users to access the stored items. In addition, those storage containers are not designed to store large items, such as ladders, folding tables, etc. The present invention aims to solve some of these problems by disclosing a vehicular storage apparatus that can be mounted onto the rear cargo area of a pickup truck.

### SUMMARY OF THE INVENTION

The present invention discloses a vehicular storage apparatus that comprises a main body, a first storage container, a second storage container, and a power source. The main body comprises a top wall, a first sidewall, a second sidewall, and a bottom wall. Each of the top wall, the first sidewall, the second sidewall, and the bottom wall extends from a first end to a second end to form an interior space A first partition is vertically positioned in the interior space to divide the interior space into a first compartment and a second compartment. The first storage container comprises a first storage compartment. The first storage container is positioned on top of the main body. The second storage container comprises a second storage compartment. The second storage container is positioned on top of the first storage container. Each of the first storage compartment and the second storage compartment extends longitudinally between the first end and the second end.

One or more of the following features may be included. The first compartment may comprise a refrigerating compartment that maintains a temperature between 33-40° F., and the second compartment may comprise a freezing compartment that maintains a temperature below 33° F. The power source may be connected to the refrigerating compartment and the freezing compartment. Each of the first compartment and the second compartment may be provided with a door. Each of the door of the first compartment and the door of the second compartment may comprise a handle and a locking mechanism. A second partition may be horizontally positioned in the first compartment to divide the first compartment into a first sub-compartment and a second sub-compartment. The first sub-compartment may be provided with a microwave oven. The second sub-compartment may comprise a refrigerating compartment that maintains a temperature between 33-40° F., and the second compartment may comprise a freezing compartment that maintains a temperature below 33° F. The power source may be connected to the microwave oven, the refrigerating compartment, and the freezing compartment. The first storage container may comprise a first sliding tray. The second storage container may comprise a second sliding tray. The first storage container may comprise a first storage container door. The second storage container may comprise a second storage container door. The first sliding tray may be connected to the first storage container door. The second sliding tray may be connected to the second storage container door. Each of the first storage container door and the second storage container door may comprise a handle and a locking mechanism. The first partition may be located in the middle of the interior space.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the present invention, showing the vehicular storage apparatus installed onto the rear cargo area of a pickup truck.

FIG. 2 depicts a top-left perspective view of the present invention.

FIG. 3 depicts a top-right perspective view of the present invention.

FIG. 4 depicts a top-left perspective view of the present invention with the door of the first sub-compartment and the door of the second sub-compartment open.

FIG. 5 depicts a top-right perspective view of the present invention with the door of the second compartment open.

FIG. 6 depicts a left-side view of the present invention.

FIG. 7 depicts a cross-sectional view of the present invention, taken along line A-A in FIG. 6.

FIG. 8 depicts a right-side view of the present invention.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of vehicular storage apparatuses, embodiments of the present disclosure are not limited to use only in this context.

The present invention is a vehicular storage apparatus that is designed for pickup trucks. The present invention comprises a main body, a plurality of storage containers, and a power source. It is an aim of the present invention to provide a novel storage apparatus in which the storage spaces are easily accessible. It is another aim of the present invention to provide a storage apparatus that incorporates a refrigerator, a freezer, and/or a microwave oven. It is yet another aim of the present invention to provide designated storage compartments for relatively large items (e.g., a ladder, a folding table, etc.).

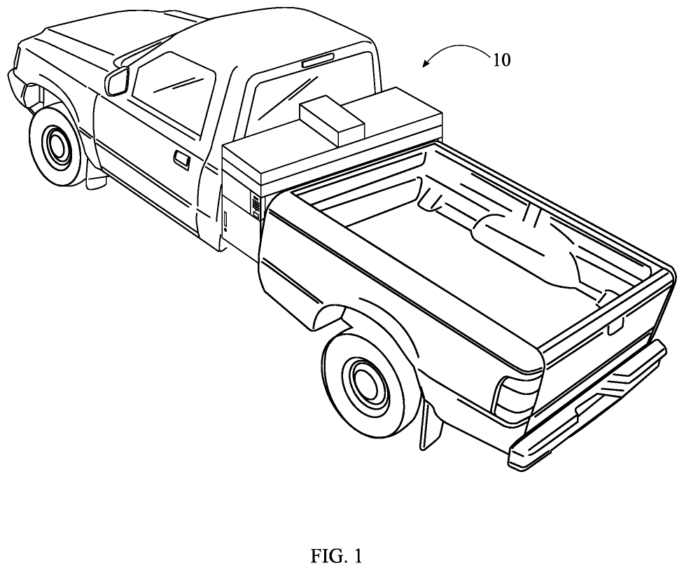

Referring now to the figures of the present disclosure. FIG. 1 is a perspective view of the present invention, showing the vehicular storage apparatus 10 installed onto the rear cargo area of a pickup truck. Preferably, the vehicular storage apparatus 10 is installed immediately behind the cabin of the pickup truck.

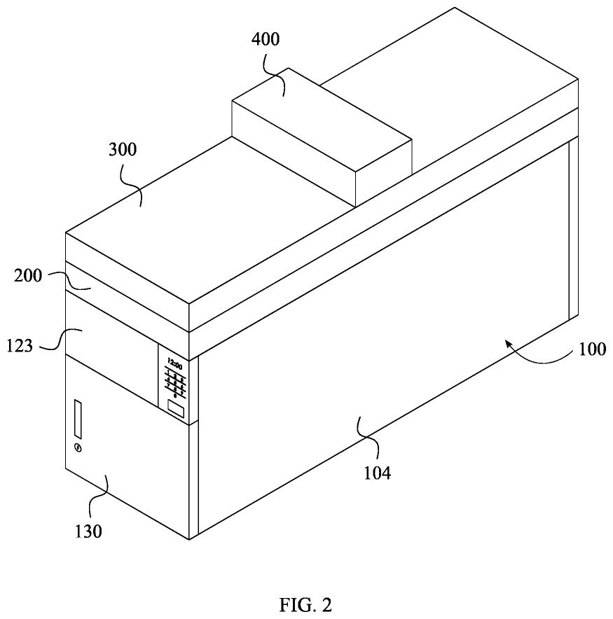

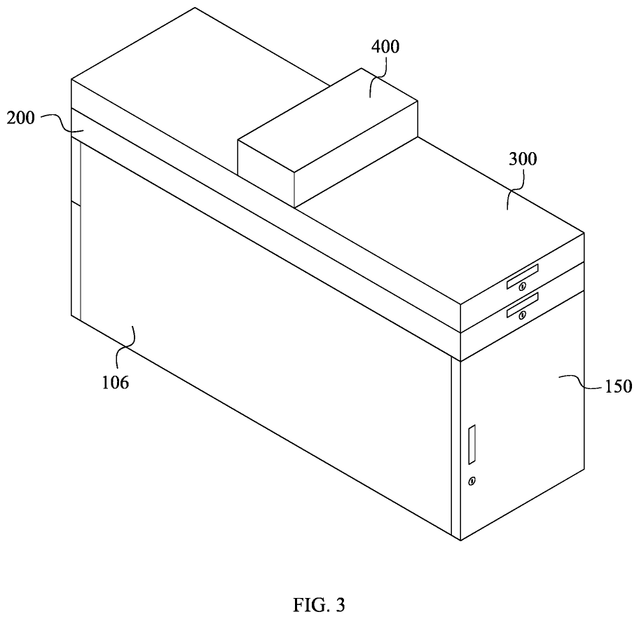

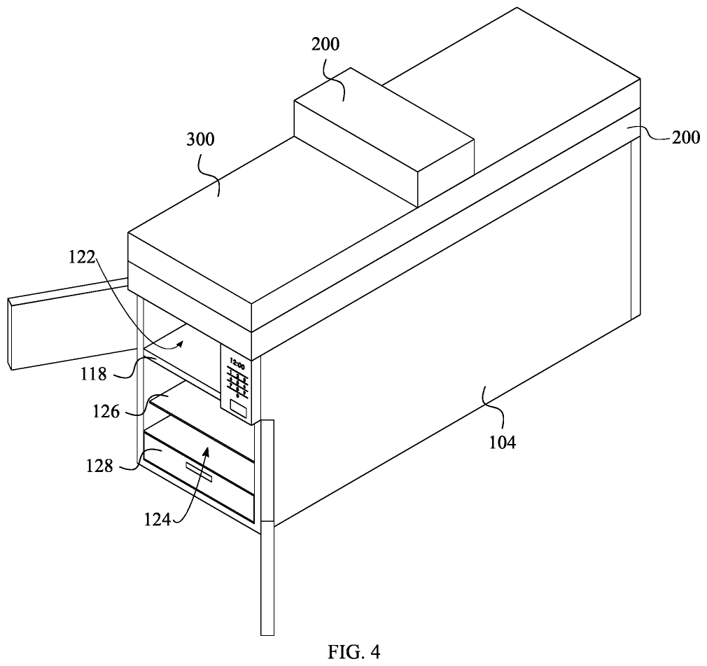

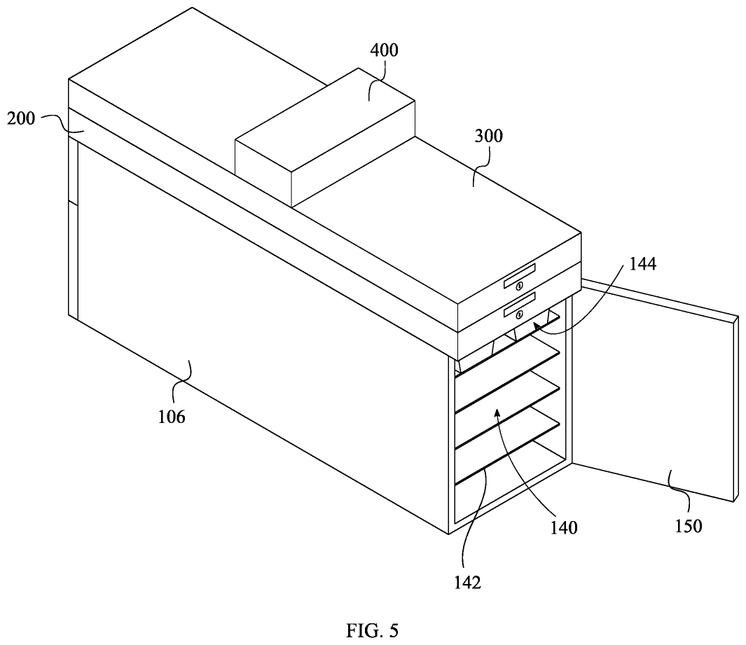

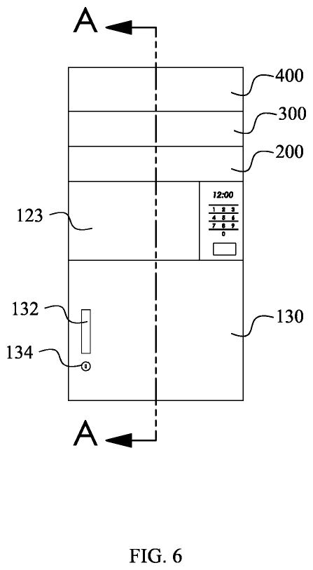

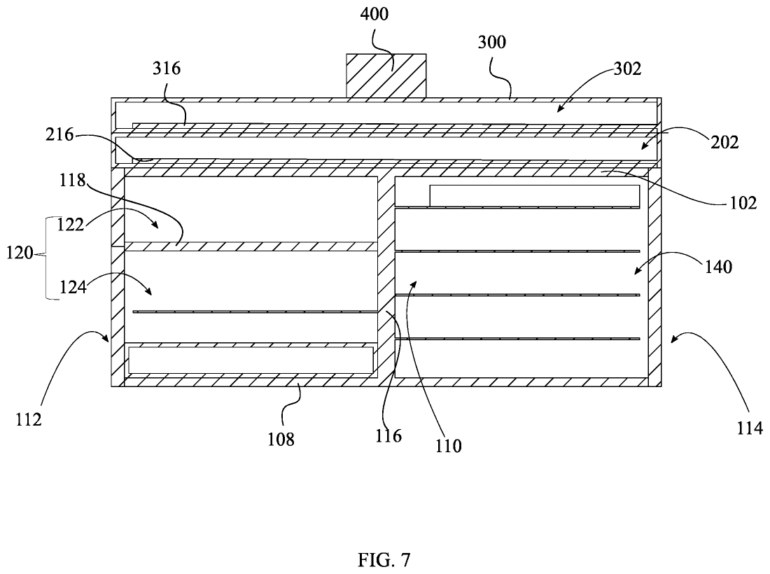

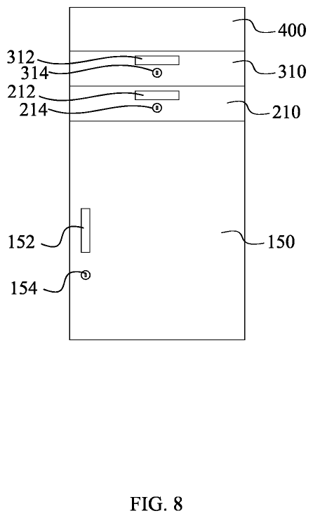

In reference to FIGS. 2-8, the main body 100 of the present invention may be of a cuboid shape. It should be noted that the main body 100 can be of any shape, size, material, features, type or kind, orientation, location, quantity, components, and arrangements of components that would allow the present invention to fulfill the objectives and intents of the present invention. In one embodiment, the main body 100 comprises a top wall 102, a first sidewall 104, a second sidewall 106, and a bottom wall 108. The top wall 102, the first sidewall 104, the second sidewall 106, and the bottom wall 108 all extend from a first end 112 to a second end 114 and thereby form an interior space 110. A first partition 116 may be vertically positioned in the interior space 110 to divide the interior space 110 into a first compartment 120 and a second compartment 140. In a preferred embodiment, the first partition 116 is located in the middle of the interior space 110. In one embodiment, the first compartment 120 may be a refrigerating compartment that preferably produces a temperature between 33-40° F. (0-4° C.), while the second compartment 140 may be a freezing compartment that preferably produces a temperature below 33° F. (0° C.) to freeze blocks of ice or store frozen foods. Each of the first compartment 120 and the second compartment 140 may comprise a door. Each door may further comprise a handle to facilitate opening and closing the door and a locking mechanism for locking the door in its closed position. For example, the door 150 of the second compartment comprises a handle 152 and a locking mechanism 154. In one embodiment, the first compartment 120 may comprise a plurality of sliding shelves that divides the first compartment 120 into a plurality of storage spaces. Further, the first compartment may further comprise a crisper bin that can slide out. The second compartment 140 may comprise a plurality of sliding shelves 142 that divides the second compartment 140 into a plurality of storage spaces and a plurality of ice trays 144.

In a preferred embodiment, the first compartment 120 is further divided by a second partition 118 into a first sub-compartment 122 and a second sub-compartment 124. Preferably, the second partition 118 may be positioned horizontally. The first sub-compartment 122 may be provided with a microwave oven and comprise a first sub-compartment door 123, while the second sub-compartment 124 is a refrigerating compartment as stated above. The second sub-compartment 124 may also comprise a plurality of sliding shelves 126 that divides the second sub-compartment 124 into a plurality of storage spaces and a crisper bin 128 that can slide out. Moreover, the second sub-compartment 124 may comprise a second sub-compartment door 130 provided with a handle 132 and a locking mechanism 134.

The plurality of storage containers is configured to store relatively large items. It should be noted that the plurality of storage containers can be of any shape, size, material, features, type or kind, orientation, location, quantity, components, and arrangements of components that would allow the present invention to fulfill the objectives and intents of the present invention. However, it is preferred that the plurality of storage containers is arranged on top of the main body. Moreover, the plurality of storage containers is preferably positioned on top of one another. Each of the plurality of storage containers may comprise a storage compartment and extend longitudinally between the first end and the second end. In the illustrated embodiment, the plurality of storage containers comprises two storage containers, i.e., a first storage container 200 and a second storage container 300. However, a different number of storage containers is also contemplated.

The first storage container 200 comprises a first storage compartment 202, while the second storage container 300 comprises a second storage compartment 302. In one embodiment, the first storage container 200 is positioned on top of the main body 100, and the second storage container 300 is positioned on top of the first storage container 200. The first storage compartment 202 and the second storage compartment 302 may extend longitudinally between the first end 112 and the second end 114 of the main body 100. For instance, the first storage compartment 202 may be used for the storage of a folding table, and the second storage compartment 302 may be used for the storage of a ladder. In a preferred embodiment, the first storage container 200 comprises a first sliding tray 216 and a first storage container door 210. The first storage container door 210 comprises a handle 212 and a locking mechanism 214, and the first sliding tray 216 is connected to the first storage container door 210. In this way, when a user pulls out the first storage container door 210, the connected first sliding tray 216 will slide out such that the stored item may be readily accessible. Similarly, the second storage container 300 comprises a second sliding tray 316 and a second storage container door 310. The second storage container door 310 comprises a handle 312 and a locking mechanism 314, and the second sliding tray 316 is connected to the second storage container door 310. Although in the illustrated embodiment the first storage container door 210 and the second storage container door 310 are arranged on the same side, they could also be arranged on opposite sides. For example, the first storage container door 210 may be located at the first end 114, while the second storage container door 310 may be located at the second end 116.

The power source 400 may be connected to refrigerating compartment, the freezing compartment, and the microwave oven to supply power thereto. The power source can be of any shape, size, material, features, type or kind, orientation, location, quantity, components, and arrangements of components that would allow the present invention to fulfill the objectives and intents of the present invention. However, it can be preferred that the power source is of the type or kind, components, and/or features similar to, but not limited to, the following: battery cells, solar energy panels, other similarly related objects, and/or any combination of the above-mentioned. Preferably, the power source 400 may be placed on top of the second storage container 300.

Although the disclosure has been explained in relation to its preferred embodiment, it is to be understood that many other possible modifications and variations can be made without departing from the spirit and scope of the disclosure.

What is claimed is:

1. A vehicular storage apparatus comprising:
a main body;
a first storage container;
a second storage container;
a power source;
the main body comprising a top wall, a first sidewall, a second sidewall, and a bottom wall;
each of the top wall, the first sidewall, the second sidewall, and the bottom wall extending from a first end to a second end to form an interior space;
a first partition being vertically positioned in the interior space to divide the interior space into a first compartment and a second compartment;
the first storage container comprising a first storage compartment;
the first storage container being positioned on top of the main body;
the second storage container comprising a second storage compartment;
the second storage container being positioned on top of the first storage container; and
each of the first storage compartment and the second storage compartment extending longitudinally between the first end and the second end.

2. The vehicular storage apparatus as claimed in claim 1, wherein the first compartment comprises a refrigerating compartment that maintains a temperature between 33-40° F.;
the second compartment comprises a freezing compartment that maintains a temperature below 33° F.; and
the power source is connected to the refrigerating compartment and the freezing compartment.

3. The vehicular storage apparatus as claimed in claim 2, wherein each of the first compartment and the second compartment is provided with a door.

4. The vehicular storage apparatus as claimed in claim 3, wherein each of the door of the first compartment and the door of the second compartment comprises a handle and a locking mechanism.

5. The vehicular storage apparatus as claimed in claim 1, further comprising:
a second partition being horizontally positioned in the first compartment to divide the first compartment into a first sub-compartment and a second sub-compartment.

6. The vehicular storage apparatus as claimed in claim 5, wherein the first sub-compartment is provided with a microwave oven;
the second sub-compartment comprises a refrigerating compartment that maintains a temperature between 33-40° F.;
the second compartment comprises a freezing compartment that maintains a temperature below 33° F.; and
the power source is connected to the microwave oven, the refrigerating compartment, and the freezing compartment.

7. The vehicular storage apparatus as claimed in claim 1, wherein the first storage container comprises a first sliding tray; and
the second storage container comprises a second sliding tray.

8. The vehicular storage apparatus as claimed in claim 7, wherein the first storage container comprises a first storage container door;
the second storage container comprises a second storage container door;
the first sliding tray is connected to the first storage container door;
the second sliding tray is connected to the second storage container door; and
each of the first storage container door and the second storage container door comprises a handle and a locking mechanism.

9. The vehicular storage apparatus as claimed in claim 1, wherein the first partition is located in the middle of the interior space.

10. A vehicular storage apparatus comprising:
a main body;
a plurality of storage containers;
a power source;
the main body comprising a top wall, a first sidewall, a second sidewall, and a bottom wall forming;
each of the top wall, the first sidewall, the second sidewall, and the bottom wall extending from a first end to a second end to form an interior space;
a first partition being vertically positioned in the interior space to divide the interior space into a first compartment and a second compartment;
the plurality of storage containers being positioned on top of the main body;
each of the plurality of storage containers comprising a storage compartment;
the plurality of storage containers being positioned on top of one another; and
each of the plurality of storage containers extending longitudinally between the first end and the second end.

11. The vehicular storage apparatus as claimed in claim 1, further comprising:
a second partition being horizontally positioned in the first compartment to divide the first compartment into a first sub-compartment and a second sub-compartment.

12. The vehicular storage apparatus as claimed in claim 11, wherein the first sub-compartment is provided with a microwave oven;
the second sub-compartment comprises a refrigerating compartment that maintains a temperature between 33-40° F.;
the second compartment comprises a freezing compartment that maintains a temperature below 33° F.; and
the power source is connected to the microwave oven, the refrigerating compartment, and the freezing compartment.

13. The vehicular storage apparatus as claimed in claim 1, wherein the first storage container comprises a first sliding tray; and
the second storage container comprises a second sliding tray.

14. The vehicular storage apparatus as claimed in claim 13, wherein the first storage container comprises a first storage container door;
the second storage container comprises a second storage container door;
the first sliding tray is connected to the first storage container door;
the second sliding tray is connected to the second storage container door; and
each of the first storage container door and the second storage container door comprises a handle and a locking mechanism.

15. The vehicular storage apparatus as claimed in claim 1, wherein the first partition is located in the middle of the interior space.

16. A vehicular storage apparatus comprising:
a main body;
a first storage container;
a second storage container;
a power source;
the main body comprising a top wall, a first sidewall, a second sidewall, and a bottom wall;
each of the top wall, the first sidewall, the second sidewall, and the bottom wall extending from a first end to a second end to form an interior space;
a first partition being vertically positioned in the interior space to divide the interior space into a first compartment and a second compartment;
a second partition being horizontally positioned in the first compartment to divide the first compartment into a first sub-compartment and a second sub-compartment;
the first storage container comprising a first storage compartment;
the first storage container being positioned on top of the main body;
the second storage container comprising a second storage compartment;
the second storage container being positioned on top of the first storage container; and
each of the first storage compartment and the second storage compartment extending longitudinally between the first end and the second end.

17. The vehicular storage apparatus as claimed in claim 16, wherein the first sub-compartment is provided with a microwave oven;
the second sub-compartment comprises a refrigerating compartment that maintains a temperature between 33-40° F.;
the second compartment comprises a freezing compartment that maintains a temperature below 33° F.; and
the power source is connected to the microwave oven, the refrigerating compartment, and the freezing compartment.

18. The vehicular storage apparatus as claimed in claim 16, wherein the first storage container comprises a first sliding tray; and
the second storage container comprises a second sliding tray.

19. The vehicular storage apparatus as claimed in claim 18, wherein the first storage container comprises a first storage container door;
the second storage container comprises a second storage container door;
the first sliding tray is connected to the first storage container door;
the second sliding tray is connected to the second storage container door; and
each of the first storage container door and the second storage container door comprises a handle and a locking mechanism.

20. The vehicular storage apparatus as claimed in claim 1, wherein the first partition is located in the middle of the interior space.
